(19) United States
(12) Patent Application Publication
(10) Pub. No.: US 2008/0088401 A1
(43) Pub. Date: Apr. 17, 2008

(54) Transformer

(75) Inventor: Po-Yu Wei, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/907,594

(22) Filed: Oct. 15, 2007

(30) Foreign Application Priority Data
Oct. 16, 2006 (TW) 95138043

(51) Int. Cl. H01F 27/30; H01F 27/28

(52) U.S. Cl. 336/182

(57) ABSTRACT

The present invention provides a transformer comprising a core set constructed by a first core and a second core. The first core and second core define a space, a circuit board with at least one hole is disposed in the space; wherein the winding assembly comprises an insulation coil with an extending portion correspondingly passing through the holes and a plurality of conductive pieces are disposed in the insulation coil.

### BACKGROUND OF THE INVENTION

1. Field of the Invention

The present invention relates to a transformer satisfying small size and low cost, and in particular, to a transformer conforming to safety standard.

2. Description of the Related Art

The transformer is an electronic component usually used in various electronic equipments. As shown in FIG. 1, the conventional transformer 1 includes a bobbin 11, a winding set 12, a socket mount 14, and an iron core set 13. The winding set 12 includes a primary winding and a secondary winding which are both respectively wound around the bobbin 11 by conductive wires. The primary and secondary windings are electromagnetic coupled to each other. The iron core set 13 consists of a first iron core 131 and a second iron core 132. The first and second iron cores 131, 132 are respectively disposed on the opposite side of the bobbin 11 and coupled together to form an electromagnetic loop.

Generally, the winding set is a winding in a concentric arrangement. The wires of the winding set 12 are directly wound around the bobbin 11. However, as the trend of small size of electronic product, the conventional transformer is relatively bigger in size which does not conform to the requirement of new product nowadays. Accordingly, a further developed transformer 2, as shown in FIG. 2, uses a plate circuit board 22 with spiral loop. The structure of the electromagnetic loop made by stacked plate circuit boards 22 generates the electromagnetic induction. The structure of the electromagnetic loop may reduce the volume of the transformer, and also greatly increase the component cost of the transformer.

As mentioned before, it is an important issue for the related industry to provide a transformer of small size which satisfies the requirement for small size electronic product, reduces component cost thereof, and conforms to safety standard.

### BRIEF SUMMARY OF INVENTION

Accordingly, it is an object of the present invention to provide a transformer which is light, cost effective and conforming to safety standard.

In order to achieve the above object, the present invention provides a transformer includes an iron core set, a winding assembly and a circuit board. In one embodiment of the present invention, the iron core set forms a containing space by coupling a first iron core and a second iron core together. The circuit board including a spiral loop and at least one hole and the winding assembly consisting of a multi-layer insulation coil and conduction pieces are disposed in the containing space, wherein the conduction pieces is disposed in the insulation coil.

In order to achieve the above object, the hole on the circuit board may electrically connect to an external circuit through lead pins. The insulation coils and conduction pieces also include extension parts for electrically connecting to the external circuit. Furthermore, the iron core set includes a convex part for passing through openings of the circuit board, the conduction pieces and the wound multi-layer insulation coils for producing electromagnetic inducted modulation current by the stack assembling of the iron core set.

Furthermore, each of the circuit board, insulation coils and conduction pieces is coated or pressed on the insulation material. The insulation coils and the conduction pieces are integrally formed with an enamel wire and a copper sheet, respectively.

A detailed description is given in the following embodiments with reference to the accompanying drawings.

### BRIEF DESCRIPTION OF DRAWINGS

The present invention will be more fully understood from the subsequent detailed description and the accompanying drawings, which are given by way of illustration only, and thus are not limitive of the present invention, and wherein:

FIG. 1 is a schematic drawing showing a conventional transformer.

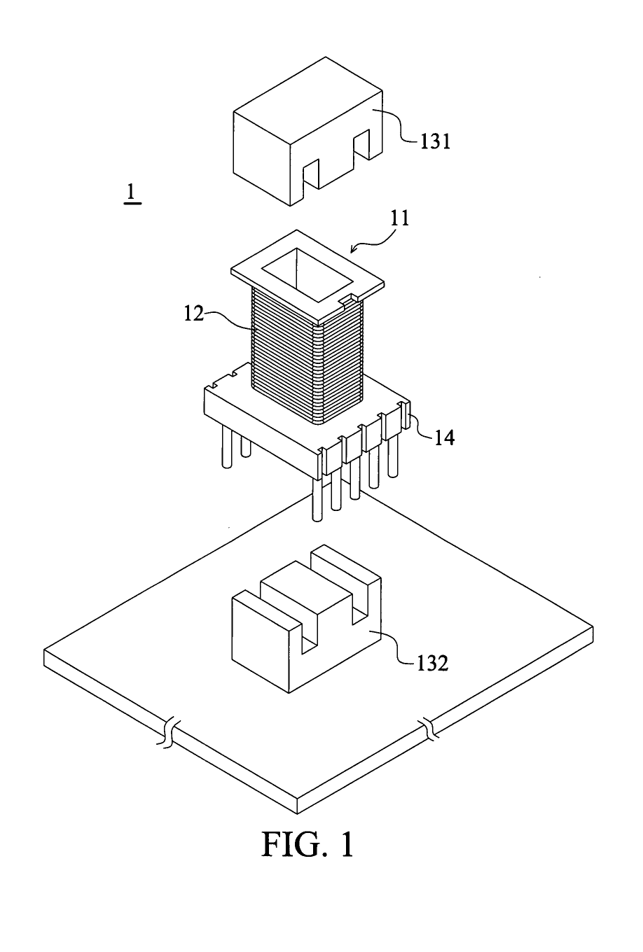

FIG. 2 is a schematic drawing showing another conventional transformer.

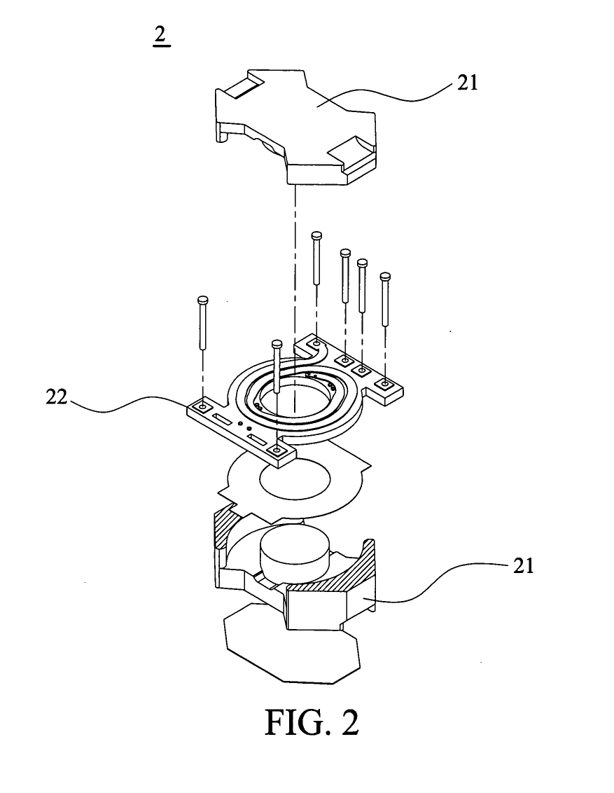

FIG. 3A is a schematic drawing showing the assembled transformer according to a preferred embodiment of the present invention.

FIG. 3B is an exploded pictorial drawing showing the transformer according to the preferred embodiment of the present invention.

FIG. 4 is a top view showing the assembled transformer according to the preferred embodiment of the present invention.

### DETAILED DESCRIPTION OF INVENTION

Further scope of the applicability of the present invention will be apparent from the detailed description given hereinafter. However, it should be understood that the detailed description and specific examples, while indicating preferred embodiments of the (present) invention, are given by way of illustration only, since various changes and modifications within the spirit and scope of the invention will become apparent to those skilled in the art from this detailed description.

The following embodiment will be described according to the related drawing of a transformer of a preferred embodiment of the present invention, wherein the same element will illustrate in the same reference numerals.

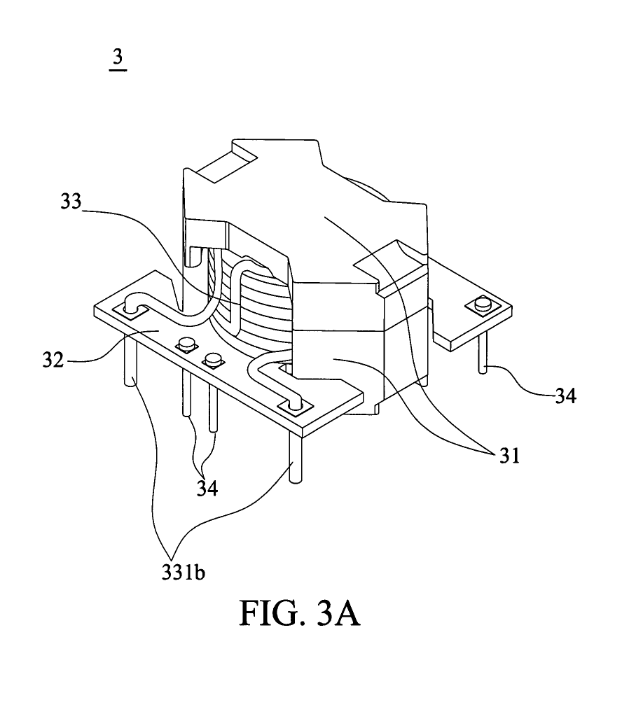

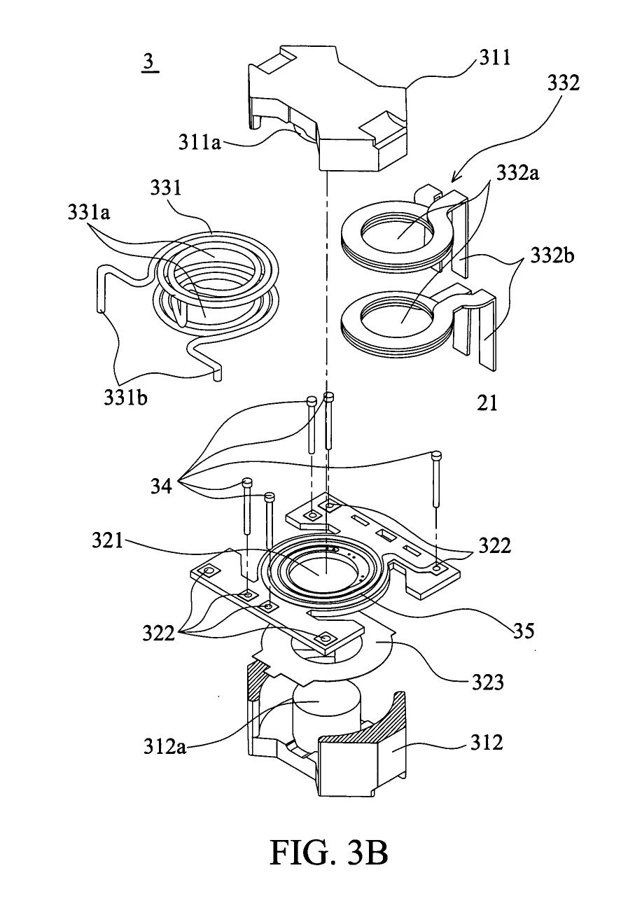

As shown in FIGS. 3A and 3B, a transformer 3 according to a preferred embodiment of the present invention includes an iron core set 31, a circuit board 32 and a winding assembly 33. The transformer 3 is used in an electronic device.

The iron core set 31 has a first iron core 311 and a second iron corn 312. The first and second iron cores 311, 312 define a space thererbetween for disposing the circuit board 32 and the winding assembly 33. The winding assembly 33 further includes an insulation coil 331 and a conduction piece 332, and the conduction piece 332 is placed between the structures of double layer wound by the insulation coil 311. The first and second iron cores 311, 312 of the iron core set 31 on their assembling surface further respectively includes a convex part 311a and 312a. The convex parts 311a and 312a can pass through an opening 321 in the circuit board 32, a circular opening 331a of the insulation coil 331 in the winding assembly 33 and a round opening of the conduction piece 332 to ensure the circuit board 32 and the winding assembly 33 being fixed by the iron core set 31 and to generate electromagnetic couple induction, thereby achieving to the objective of voltage transform.

In the present embodiment, the circuit board 32 of the transformer 3 further includes a spiral loop 35 and at least one hole 322. The lead pin terminals 34 may connect with an external circuit (not shown) by passing through the holes 322. The insulation coil 331 and the conduction piece 332 respectively have integrally formed extension parts 331b and 332b for electrical connection to the external circuit. The extension part 331b of the insulation coil 331 can be a terminal for electrical connection without further adding lead pins so that the process and the cost can be saved.

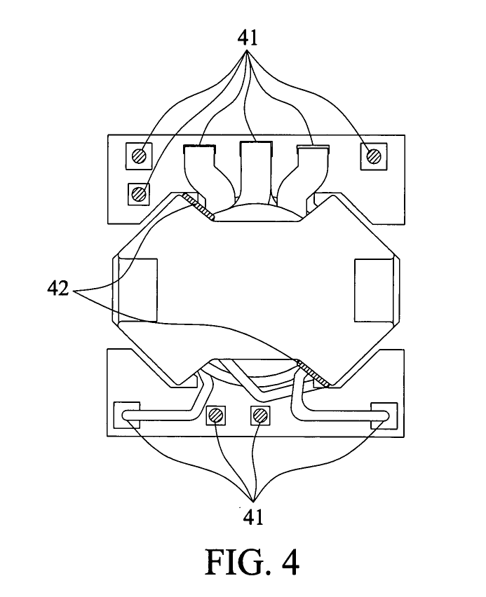

FIG. 4 is a top view showing the assembled transformer according to the preferred embodiment of the present invention. As shown in FIG. 4, the assembled transformer 3 includes a plurality of pins 41 electrically connected to the external circuit (not shown), and fixed by plastic material 42 during the packaging to enhance the rigidity of entire structure.

Additionally, the conduction piece 322 is a cooper sheet or other conductive materials. The circuit board 32 and the winding assembly 33 are both coated by insulation material, wherein the insulation coil 331 in the winding assembly 33 is an enamel wire. Furthermore, the transformer of the preferred embodiment according to the present invention further includes an insulation layer 323, which is a polymide insulation material and can be pressed on the circuit board 32. The embodiment of the present invention employs various stacked insulation material winding set so there is no requirement of making a bobbin mold and it can be apply to plate transformer of DC-DC and AC-DC mode, further conforming to the requirement of safety code (EN60950). In addition, the elements of the preferred embodiment can collocate the number of the winding set and the coil flexibly, and increase the scope of the transformer application greatly as well.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A transformer comprising:
a first core and a second core coupled together and forming a containing space thererbetween;
a circuit board disposed in the containing space and comprising at least one hole; and
a winding assembly disposed in the containing space,
wherein the winding assembly comprises:
an insulation coil comprising an extension part, each of the extension part correspondingly passing through the hole; and
a conduction piece disposed in the insulation coil.

2. The transformer of claim 1, wherein the circuit board comprises a spiral loop.

3. The transformer of claim 1, wherein the circuit board electrically connects to an external circuit by at least one pin passing through the at least one hole.

4. The transformer of claim 1, wherein the surface of the circuit board comprises an insulation material.

5. The transformer of claim 4, wherein the insulation material is polymide.

6. The transformer of claim 1, wherein the extension part of the insulation coil is a pin electrically connecting to an external circuit.

7. The transformer of claim 1, wherein the insulation coil is winding a continuous wire.

8. The transformer of claim 1, wherein the continuous wire is a flat or enamel wire.

9. The transformer of claim 1, wherein the surface of the insulation coil comprises an insulation material.

10. The transformer of claim 1, wherein the conduction piece comprises an integrally formed extension part.

11. The transformer of claim 1, wherein the surface of the conduction piece comprises an insulation material.

12. The transformer of claim 1, wherein the conduction piece is a cooper sheet.

13. The transformer of claim 1, wherein each of the circuit board and the conduction thin comprises an opening.

14. The transformer of claim 13, wherein the first and second cores comprise at least a convex part for passing through the opening.

15. The transformer of claim 1, wherein the insulation coil has a two-layer structure.

16. The transformer of claim 1, further comprising an insulation layer disposed on the circuit board.

17. The transformer of claim 16, wherein the insulation layer is made of polymide.

18. The transformer of claim 1, wherein the insulation coil is an enamel wire.
